(19) United States
(12) Patent Application Publication
(10) Pub. No.: US 2011/0023231 A1
(43) Pub. Date: Feb. 3, 2011

(54) PATIENT ASSISTANCE DEVICE

(76) Inventors: John A. Thomas, Dallas, TX (US); Phillip A. Clifford, Dallas, TX (US)

Correspondence Address: CARSTENS & CAHOON, LLP, 13760 NOEL ROAD, SUITE 900, DALLAS, TX, 75240, US

(21) Appl. No.: 12/903,992

(22) Filed: Oct. 13, 2010

Related U.S. Application Data
(63) Continuation-in-part of application No. 12/473,068, filed on May 27, 2009.

(51) Int. Cl. A61G 7/10; A62B 35/00

(52) U.S. Cl. 5/81.1 T

(57) ABSTRACT

A device for assisting a caregiver in lifting and moving a patient. The device comprises a waist belt that includes a separate “glute” strap, which wraps around the patient's buttocks. Both the waist belt and the glute strap are fully adjustable to ensure a snug, comfortable fit. The device may further include a unitary garment member having a plurality of integral, reinforced support straps that enhance the structural strength of the garment member. The unitary garment member includes two flap portions extending laterally on opposing sides of a rear panel section that can be pulled forward and attached to a front panel section transforming the device into a vest-type garment that completely surrounds the patient's torso. The device includes a plurality of strategically positioned hand holds, which provide enhanced leverage enabling a caregiver to more easily assist a patient wearing the device to move from one position to another.

### CROSS-REFERENCE TO RELATED APPLICATION

This application is a continuation-in-part of U.S. patent application Ser. No. 12/473,068 filed on May 27, 2009.

### BACKGROUND OF THE INVENTION

1. Technical Field of the Invention

The present invention relates to an apparatus for assisting a caregiver in the lifting and/or positioning of a disabled person or patient. The patient transfer apparatus of the present invention is designed for patients requiring caregiver assistance for ambulating from a sitting position to a standing position, and/or when transferring from one position to another. In addition, once the patient is ambulated to a standing position, the present invention also enables a caregiver to stabilize the patient's upper torso to reduce the risk of the patient falling when walking.

The apparatus is intended to be used for the elderly, developmentally disabled, or those with physical limitations that require one or more persons to assist them. In particular, the present invention relates to an apparatus for assisting both the caregiver, as well as a person/patient who can partially bear weight, yet requires assistance with transferring, repositioning and/or walking.

2. Description of the Related Art

A variety of proposals have previously been made to provide some type of patient lifting or transfer devices that enables a caregiver to safely assist a patient in moving from one position to another. By “patient” is meant any person irrespective of age, sex, health condition, physical impairment or disability that requires, even if only occasionally, assistance in moving or transferring. Such incapacitated individuals, whether short-term or long-term, oftentimes require assistance from another person(s) when being moved, for example, into or out of beds, to and from a chair, to and from a toilet, car or sitting positions, even during physical therapy or the like. In particular, persons confined to wheelchairs, are often unable to stand on their own and require the assistance of one or more caregivers to move them from a wheelchair or other seating arrangement or to a standing position, or oftentimes to get into and out of a bath or shower chair.

Prior art lifting devices have previously employed mechanical lifts, which commonly have a sling for the patient to be raised and lowered, waist belts (commonly referred to as a “gait belt”), as well as hybrid non-mechanical lifts commonly referred to as “sit-to-stand” lifts for patients. In spite of a wide variety in the design of these lifting and transfer devices, each has its own inadequacies. For example, a variety of mechanical lifts, which include manual, hydraulic and electrical devices, are typically used for patients who cannot bear any weight, and/or for bariatric patients that require full assistance (referred to as non-ambulatory). These lifting devices are also known to be very bulky, hard to maneuver, and in many cases cannot fit in the most common areas for transferring, such as to and from the bathroom for toileting and bathing. In the healthcare setting, like a nursing home or hospital, some of the most common drawbacks are 1) lack of training to caregivers/nurses to properly utilize the equipment, and 2) the amount of time it takes to transfer a patient as these lifts typically take several minutes to transfer a patient. It is, therefore, not surprising that caregivers must oftentimes get two to three caregivers to do a manual transfer rather than attempting to locate the transfer equipment, especially for those patients who can partially bear weight. In addition, storing these bulky lifts becomes a life safety code issue when not in use and have even contributed to patient falls if positioned in the hallway. Indeed, manually lifting a patient/person is the most common type of transfer worldwide for patients who can partially bear weight yet require assistance.

Similarly, the prior art waist or “gait” belt devices have also proven problematic. A gait belt is a padded belt that fits around the patient's lower rib area and usually comes with multiple handles that are used to grab the patient. Some of the commonly known drawbacks of gait belt devices include 1) they are uncomfortable for the patient, 2) they have a tendency to slide up or down during transfer, making the transfer difficult while also hurting the patient, especially for women due to breast issues, 3) they can actually contribute to a patient falling due to the fact that the upper torso of the patient is never stabilized during the transfer process, and 4) they can cause skin tears, bruising, as well as inappropriate touching to the patient. In addition, when a gait belt device is used to transfer a patient, the caregiver puts themselves at risk to potential injury (e.g., back and shoulder injuries), especially if this transfer position is repeated over and over.

While prior art sit-to-stand lifting/transfer devices are quicker than the traditional mechanical lift, they also exhibit several common drawbacks, including 1) they typically require the patient to be able to hold onto handles while the patient is lifted up, 2) they are also bulky and hard to push once the patient is in the device, 3) they are also very difficult to get in and out of toilet and bathing areas, and 4) it usually takes a few minutes to locate one and then do the transfer.

Due to the previously mentioned inadequacies with each of these prior art transfer devices, the most common type of patient transfer is accomplished by means of manual transfer, wherein patients are assisted by a caregiver manually grasping the patient to assist him or her in moving from one position to another. Such manual grasping techniques are usually difficult and oftentimes dangerous to both the patient and the caregiver. Caregivers typically grasp the patient by their arms or their belt to assist in hoisting them from one position to another position (e.g., a wheelchair or a seated position). In other instances, to gain leverage caregivers grab articles of clothing such as a trouser seat or shirt collar, however, these garments are not designed or adapted for easy grasping, and sometimes tear, and require a strong grip on the part of the caregiver. This technique is not only uncomfortable for the patient, it can also cause bruising, skin tears, and even broken ribs, or even contribute to a patient falling and sustaining more serious injuries.

Further, because of the difficulty of grasping hold of a patient that needs to be moved from one position to another, a caregiver frequently sustains injuries to himself or herself such as an injured back. Injuries to caregivers are particularly likely due to the arching of the back in an unfavorable ergonomic position when attempting to assist a patient with transfer.

Certain patents and publications have disclosed concepts associated with assisting handicapped or incapacitated patients, but none meet the needs filled by the present invention. For example, U.S. Pat. No. 6,122,778 issued Sep. 26, 2000 to Cohen describes a loose-fitting vest or garment-like device which enables caregivers to assist a patient in moving from one position to another. Such vest is distinguishable from the present invention because it comprises a lifting harness loosely attached to a garment vest. The harness includes a waist and chest belts attached by two shoulder straps. The waist and chest belts are adjustable (which typically takes approximately 3-5 minutes to adjust to any one patient) and include a buckle for releasable attachment around the patient. The lifting harness includes multiple handholds for assisting a caregiver in grasping the patient, although the handholds can become uncomfortable to the caregivers hands, especially if the caregiver is and elderly spouse with arthritis. However, the garment vest is not part of the skeletal lifting structure of the device. Instead, the garment vest is essentially used to properly orient the lifting harness about the patient's upper body. Moreover, the configuration of the Cohen garment vest itself can be difficult for patients in a supine position or with limited arm and shoulder flexibility to put on or to remove. Moreover, the Cohen vest can also cause irritability underneath the armpits as the vest has a tendency to slip upwards during transfer, much like the gait or waist belt. In addition, when the caregiver grabs the lifting straps to attempt a transfer, a lot of pressure is applied to the harness areas due to the fact the garment material is made of a light weight fabric, which does not provide padding for comfort, and can cause bruising, even broken ribs, especially when transferring an elderly person with osteoporosis. Lastly, the Cohen vest cannot be used by multiple patients in a healthcare setting without risking the spread of infectious diseases from one patient to another as there is no anti-microbial application to the vest itself.

Similarly, U.S. Pat. No. 5,647,378 to Farnum discloses a lifting support belt constructed of an elastic, flexible rubber-like material and includes a plurality of flexible handles, which are fixed to the belt in a spaced apart relation. The Farnum design requires that the length of the belt be customized to fit different sized individuals. While useful in some situations, the handholds of the Farnum design do not provide adequate leverage to a caregiver in all situations. For example, the Farnum design does not include any means for grasping a patient's chest or shoulder area.

Thus, a continuing need exists for an improved transfer device that assists caregivers in lifting and moving patients who can partially bear weight in a wide variety of scenarios. Further, a need exists for an improved lifting assistance device that is easier to put on and take off A need also exists for an improved lifting assistance device that is more easily adjustable to a wide variety of patients. In addition, it is oftentimes useful for a patient to keep a lifting garment on for an extended period of time or a wide variety of activities. For example, it would be useful for a patient to wear an improved lifting assistance device for an extended period, wherein the device is comfortable to wear and could be used to assist the patient out of his bed or wheelchair, position him on an MRI table, assist him to and from the toilet or assist him during physical therapy. Most importantly, a need exists for an improved lifting device for patients who can partially bear weight, yet require assistance from caregivers that does not ride up the patient's torso during the transfer process, causing discomfort, dignity issues, bruising, skin tears, and the potential for broken ribs. A need also exists for an improved lifting device that provides comfortable handles for the caregiver to grab, especially if the caregiver is an elderly spouse with arthritis. Thus, a need also exists for an improved lifting assistance device, which is comfortable to wear in a wide variety of environmental scenarios, yet resistant to bacterial growth and odor so as to eliminate the spread of infectious diseases, bacterial growth or odor from one patient to another.

### SUMMARY OF THE INVENTION

The present invention overcomes many of the disadvantages of prior art lifting assistance devices by providing an improved patient assistance device that enhances the safety, dignity and security of the patient, while reducing the risk of injury to the caregiver(s). The present invention is easy to put on and take off, very comfortable to wear, highly adjustable in a matter of seconds, is padded to protect the patient from injury, allows the caregiver to be in a much better ergonomic position to reduce risk of injuring themselves, and most importantly will not ride up the patient's torso during transfer. In one embodiment, the improved patient assistance device includes vest-style garment having plurality of strategically positioned hand holds and a novel “glute” strap, which provide enhanced leverage from the hand holds down to the patients buttocks, enabling a caregiver to more easily assist a patient wearing the device to move from one position to another. In another embodiment, the improved patient assistance device includes waist belt having one or more strategically positioned hand holds and a novel “glute” strap, which provide enhanced leverage enabling a caregiver(s) to more easily assist a patient wearing the device to move from one position to another.

In one embodiment, the patient assistance device of the present invention includes a poncho-style garment in the form of a unitary member having a front panel section, a rear panel section and a central or middle section interconnecting the front and rear panel sections. The unitary garment member is generally constructed of a flexible, durable material. In one embodiment, the material comprising the unitary garment member is bonded with an anti-microbial agent for added hygienic protection. In a preferred embodiment, the unitary garment member comprises a multi-layered composite structure having a middle layer sandwiched between a polyester-blend outer shell. While in the preferred embodiment the front, central and rear panel sections of each layer of the unitary garment member is constructed from a single, homogenous piece of material, in other embodiments each layer or panel section may be constructed separately of materials having different characteristics (e.g., buoyancy, strength, flexibility, etc.), then subsequently attached to the other layers or panel sections.

The front panel section is sized and shaped to fit across the patient's solar plexus region while the rear panel section is sized and shaped to fit across the patient's back. The central section includes an opening sized and shaped for receiving a human head therethrough. The rear panel section includes two flap portions extending laterally on opposing sides of the rear panel section. The two flap portions are designed to selectively attach to the front panel section so that when properly configured the patient assistance device effectively becomes a vest-type garment that completely surrounds the patient's torso. To facilitate the selective attachment of the flap portions to the front panel section, segments of the two flaps portions are covered with a layer of attachment fabric in the form of hook-and-loop type fastening members. In a preferred embodiment, the flap portions are configured in an overlapping arrangement.

The patient assistance device further includes a plurality of integral, reinforced support straps that are incorporated into the unitary garment member. The plurality of support straps enhance the structural integrity of the unitary garment member by transferring and distributing a load applied to one support strap to the entire patient assistance device. The plurality of support straps include two laterally spaced shoulder support straps that are positioned over the patient's shoulders and extend the length of the unitary garment member. In addition, two back support straps are configured in a criss-cross or crossbuck arrangement across the rear panel section. The ends of the back support straps are attached to the two shoulder support straps, thereby enhancing the structural rigidity of the rear panel section. In addition, each flap portion of the rear panel section includes a support strap that is laterally spaced from its respective shoulder support strap.

The patient assistance device further includes a “glute” strap, which is attached to the unitary garment member and wraps around (i.e., extends laterally across) the gluteus maximus or buttocks of the patient. The glute strap may be attached to a waist belt incorporated into the unitary garment member or preferably to the front panel section of the unitary garment member. In a preferred embodiment, the glute strap comprises a polyurethane-coated nylon webbing belt or strap that is easy to clean and sanitize.

The patient assistance device further includes one or more strategically positioned hand holds that are attached to the support straps. The hand holds provide enhanced leverage, which enables the caregiver to more easily assist a patient wearing the device to move from one position to another, while keeping the upper torso of the patient stabilized during and after the transfer process. For example, hand holds positioned on the front of the device are attached to the vertical support straps, which direct the lifting force to the glute strap, which in turn transfers the lifting force to the buttocks region thereby preventing the vest from riding up the patient during the transfer process. In one embodiment, the hand holds comprise straps of reinforced webbing material attached to the support straps. In a preferred embodiment, the hand holds further comprise plastic handles attached to the straps.

In a second embodiment, the patient assistance device of the present invention comprises a waist belt having a “glute” strap incorporated therein that provides enhanced leverage and keeps the waist belt from riding up during the transfer, enabling a caregiver to assist a patient wearing the device to move from one position to another. Both the waist belt and glute strap are fully adjustable to ensure a snug and comfortable fit around the patients lower torso and buttocks area. The waist belt may further include one or more lateral hand holds. The lateral hand holds may further comprise flat handle grips, which improve the ergonomics and leverage of the hand holds.

### BRIEF DESCRIPTION OF THE DRAWINGS

A more complete understanding of the method and apparatus of the present invention may be had by reference to the following detailed description when taken in conjunction with the accompanying drawings, wherein:

FIG. 1 is a front perspective view of a first embodiment of the patient assistance device of the present invention;

FIG. 2 is a top plan view of the device shown in FIG. 1 in a fully opened configuration;

FIG. 3 is a bottom plan view of the device shown in FIG. 1 in a fully opened configuration

FIG. 4 is a front elevation view of the device shown in FIG. 1 as worn by a patient;

FIG. 5 is a back elevation view of the device shown in FIG. 1 as worn by a patient;

FIG. 6 is a side elevation view of the device shown in FIG. 1 as worn by a patient;

FIG. 7 is a front perspective view of a second embodiment of the patient assistance device of the present invention;

FIG. 8 is a top plan view of the device shown in FIG. 7 in an opened configuration;

FIG. 9 is a bottom plan view of the device shown in FIG. 7 in an opened configuration;

FIG. 10 is an exploded perspective view of the device shown in FIG. 8;

FIG. 11 is a top plan view of an embodiment of the intermediate layer of the device shown in FIG. 10;

FIG. 12 is a front elevation view of the device shown in FIG. 7 as worn by a patient;

FIG. 13A is a back elevation view of the device shown in FIG. 7 as worn by a patient;

FIG. 13B is a back elevation view of an alternate embodiment of the device shown in FIG. 7;

FIG. 14 is a side elevation view of the device shown in FIGS. 7 and 13A as worn by a patient; and

FIG. 15 is a front perspective view of a third embodiment of the patient assistance device of the present invention.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

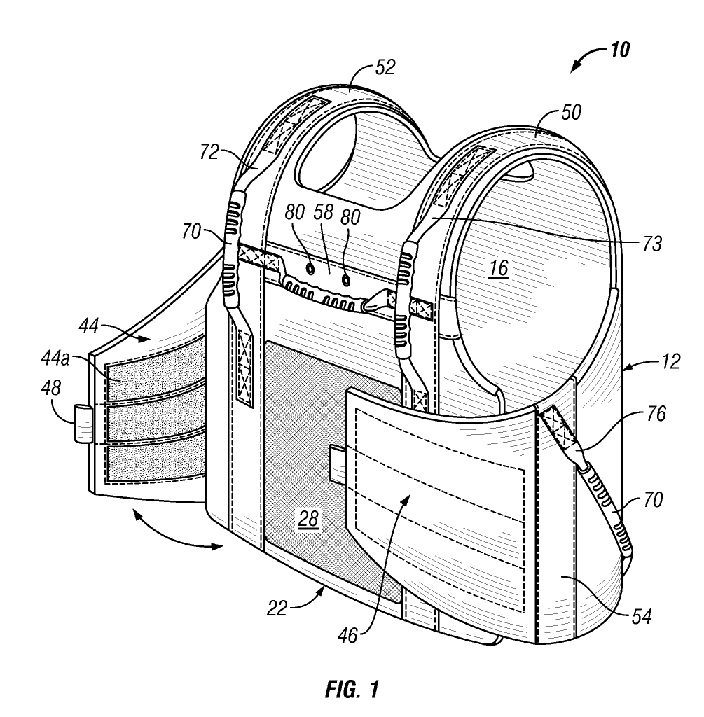

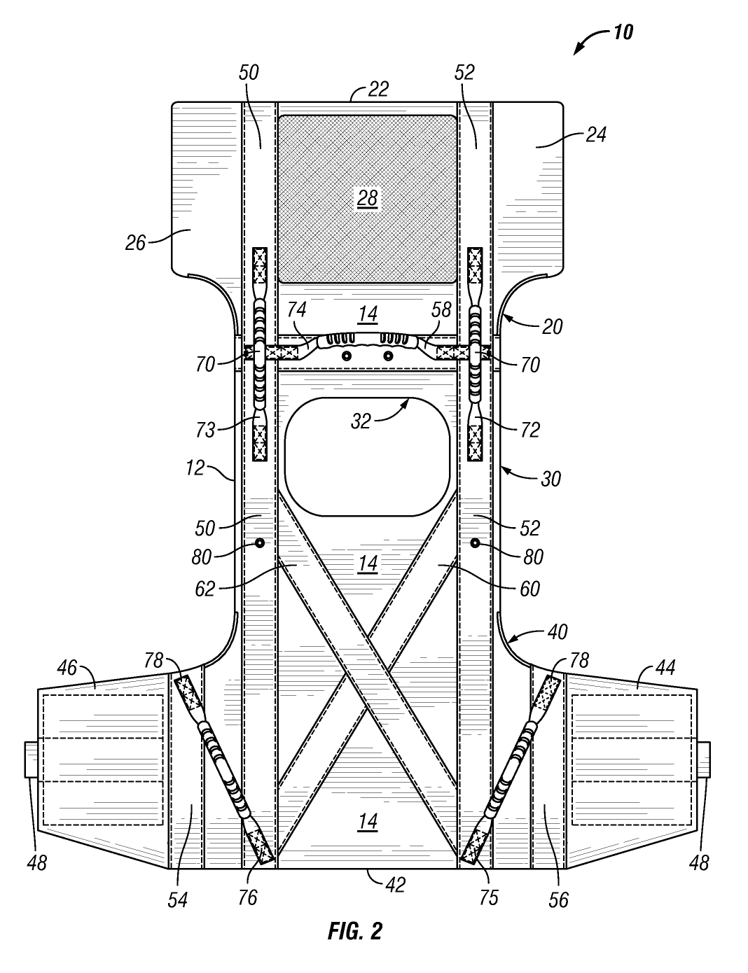

With reference to FIGS. 1-6, and in particular FIGS. 1 and 2, a first embodiment of the patient assistance device 10 of the present invention is shown. The patient assistance device 10 comprises a reinforced poncho-vest garment worn by a patient. The device 10 assists caregivers in lifting and moving the patient in a wide variety of scenarios. The device 10 is designed to be easily donned and removed from a patient.

The patient assistance device 10 of the present invention comprises a poncho-style garment in the form of a unitary member 12 having a front panel section 20, a rear panel section 40 and a central or middle panel section 30 interconnecting the front and rear panel sections. The front panel section 20 is sized and shaped to fit across the patient's chest area while the rear panel section 40 is sized and shaped to fit across the patient's back. The central panel section 30 includes an opening 32 sized and shaped for receiving a patient's head therethrough. The front panel section 20 may further include wing portions 24, 26 that extend laterally from opposing sides of the front panel section 20.

The unitary garment member 12 is generally constructed of a flexible, durable material. For example, in one embodiment the material comprises a neoprene rubber material. Preferably, the material comprising the unitary garment member 12 is also bonded with an anti-microbial agent (e.g., AEM 5700) for added hygienic protection. In a one embodiment, the material comprises a polyester blend outer shell and multiple layers of neoprene rubber treated with an anti-microbial agent and bonded with adhesive under pressure. In a preferred embodiment, the neoprene layers are treated with an anti-microbial agent so as to form a covalent bond with the neoprene. While in the preferred embodiment the front 20, central 30 and rear 40 panel sections of the unitary member 12 are constructed from a single, homogenous sheet of composite material, in other embodiments each panel section may be constructed separately of materials having different characteristics (e.g., buoyancy, strength, flexibility, etc.), then subsequently attached to the other panel sections.

The rear panel section 40 includes two flap portions 44, 46 extending laterally on opposing sides of the rear panel section 40. The inner-facing surface 16 of the two flaps 44, 46 are covered with a layer of attachment fabric 44a, 46a in the form of hook-and-loop type fastening members. A complementary layer of the attachment fabric 28 covers a substantial portion of the outer-facing surface 14 of the front panel section 20 so that when the patient assistance device 10 is properly configured on a patient, the two flap portions 44, 46 of the rear panel section 40 can be pulled forward underneath the patient's arms and selectively attached to the outer-facing surface of the front panel section 20. The two flap portions 44, 46 are of sufficient length so as to be adjustable along the lateral width of the complementary layer of the attachment fabric 28 fixably attached to the front panel section 20. Pull tabs 48 may be attached to the distal ends of the two flap portions 44, 46 to provide leverage in pulling the two flap portions 44, 46 away from the complementary layer of the attachment fabric 28 attached to the front panel section 20.

As shown in FIG. 1, when the two flap portions 44, 46 of the rear panel section 40 are properly attached to the outer-facing surface of the front panel section 20, the patient assistance device 10 effectively becomes a vest-type garment designed to completely surround the patient's torso. The fit of the vest-type garment device 10 is easily adjusted by varying the position of the two flap portions 44, 46 on the lateral width of the complementary layer of the attachment fabric 28 attached to the front panel section 20.

The patient assistance device 10 further includes a plurality of integral, reinforced support straps that are firmly attached to the unitary garment member 12. The support straps are generally constructed of a reinforced webbing material that is flexible but stretch resistant. For example, in a preferred embodiment the support straps comprise ballistic nylon webbing. The support straps are attached to the unitary garment member 12 by adhesive bond, reinforced stitching 78 or a combination thereof. The plurality of support straps enhance the structural integrity of the unitary garment member 12 by transferring and distributing a load applied to one support strap to the entire patient assistance device 10.

The plurality of support straps include two laterally spaced shoulder support straps 50, 52 that extend longitudinally from the edge 42 of the rear panel section 42 to the edge 22 of the front panel section 20, and are positioned on the unitary garment member 12 so as to pass on opposing lateral sides of the head opening 32 in the middle panel section 30.

In addition, two back support straps 60, 62 are configured in a criss-cross or crossbuck arrangement across the rear panel section 40. The ends of the back support straps 60, 62 are attached to the two shoulder support straps 50, 52 thereby enhancing the structural rigidity of the rear panel section 40. Similarly, the front panel section 20 includes a lateral support strap 58 that extends between the two shoulder support straps 50, 52 enhancing the structural rigidity of the front panel section 20. Finally, each flap portion 44, 46 of the rear panel section 40 includes a support strap 54, 56 that is laterally spaced from its respective shoulder support strap 50, 52.

The patient assistance device 10 further includes one or more strategically positioned hand holds that are attached to the support straps. The hand holds provide enhanced leverage, which enables a caregiver to more easily assist a patient wearing the device to move from one position to another. The hand holds comprise straps of reinforced webbing material fixably attached to the support straps. The ends of the hand holds may be attached to the support straps by adhesive bond, mechanical bond (e.g., rivets (not shown) or reinforced stitching 78) or a combination thereof. The hand holds may further comprise plastic handles 70 attached to the straps.

The embodiment of the patient assistance device 10 depicted in the Figures includes five hand holds. Matching hand holds 72, 73 are configured on opposing support straps 52, 50 on the front panel section 20. The front hand holds 72, 73 are positioned so that, when the vest 10 is properly configured on a patient, they are situated adjacent to the patient's sternum region. A lateral hand hold 74 attached to the support straps 50, 52, 58 is also provided that spans the patient's sternum region. Two side hand holds 75, 76 having one end attached to its respective shoulder support straps and another end attached to its respective side support strap are also provided. For example, as illustrated in the depicted embodiment, the left side hand hold 76 has one end attached to the left shoulder support strap 50 near the bottom edge 42 of the rear panel section 40 and a second end attached near the top of the left side support strap 54. Similarly, the right side hand hold 75 has one end attached to the right shoulder support strap 52 near the bottom edge 42 of the rear panel section 40 and a second end attached near the top of the right side support strap 56.

The patient assistance device 10 may further include one or more grommets 80, which improve the breathability of the garment member 12, further enhancing the comfort of the patient wearing the assistance device 10. The grommets 80 form an aperture through the patient assistance device 10 that permits air and water vapor to flow more freely from the device's interior to the ambient exterior and vice-versa. In one embodiment, the grommets 80 are constructed from poly-carbon resin pellets. In the embodiment depicted in the Figures, one or more grommets 80 are spaced along the support straps of the vest device 10.

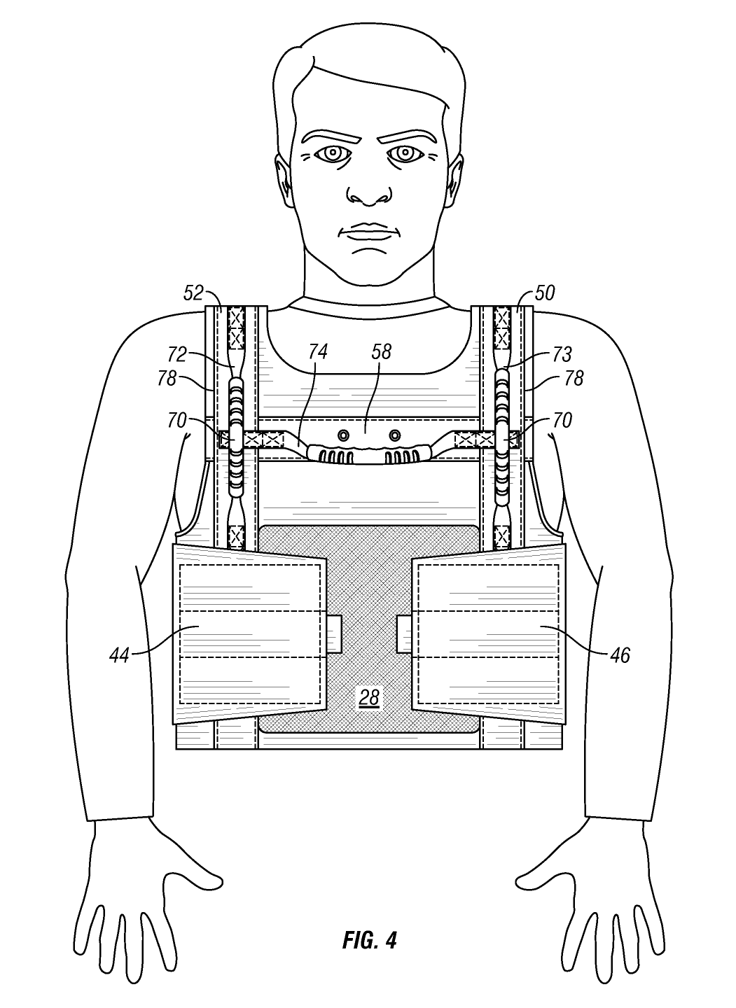

With reference FIGS. 4-6, the first embodiment of the patient assistance device 10 of the present invention is depicted as properly configured on a patient. Preferably, the patient wears a light fabric undergarment under the patient assistance device 10. The undergarment may also be treated with an anti-microbial agent for added hygienic protection. The patient's head is inserted through the opening 32 so that the central panel section 30 is positioned over the patient's shoulders with the front panel section 20 situated over the patient's chest and the rear panel section 40 is situated over the patient's back. As shown in the Figures, when the patient assistance device 10 is properly configured on a patient, the bottom edge 22 of the front panel section 20 is positioned adjacent to the patient's waistline region and the bottom edge 42 of the rear panel section 40 is positioned adjacent to the patient's lower back region.

The two flap portions 44, 46 are then pulled forward and over the wings 24, 26 of the front panel section 20, and securely attached to the attachment fabric 28 on the front panel section 20 by means of the previously disclosed hook-and-loop type attachment fabric 44a, 46a covering the inner-facing surface 16 of the two flaps 44, 46. When thus attached, the two flap portions 44, 46 form a wide belt around the patient's torso effectively locking the patient assistance device 10 securely in place forming a snug fit with the patient. The front, central and rear panel sections of the unitary garment member 12 thus form a cohesive vest garment that surround the surround the patient's torso.

The plurality of integral, reinforced support straps provide further structural firmness and support. Moreover, when the patient assistance device 10 is transformed into the cohesive vest garment shown in the Figures, the configuration of the individual support straps provide a structural web of mutual support. As shown in the Figures, the shoulder support straps 50, 52 are aligned vertically on the front 20 and rear 40 panel sections. The flap support straps 54, 56 are similarly aligned vertically under the patient's axilla on the side torso or rib cage region. The two back support straps 60, 62 are configured in a criss-cross or crossbuck arrangement across the rear panel section 40. The ends of the back support straps 60, 62 are attached to the two shoulder support straps 50, 52 thereby enhancing the lateral structural rigidity of the rear panel section 40. Similarly, the lateral support strap 58 extending between the two shoulder support straps 50, 52 on the front panel section 20 enhance the lateral structural rigidity of the front panel section 20.

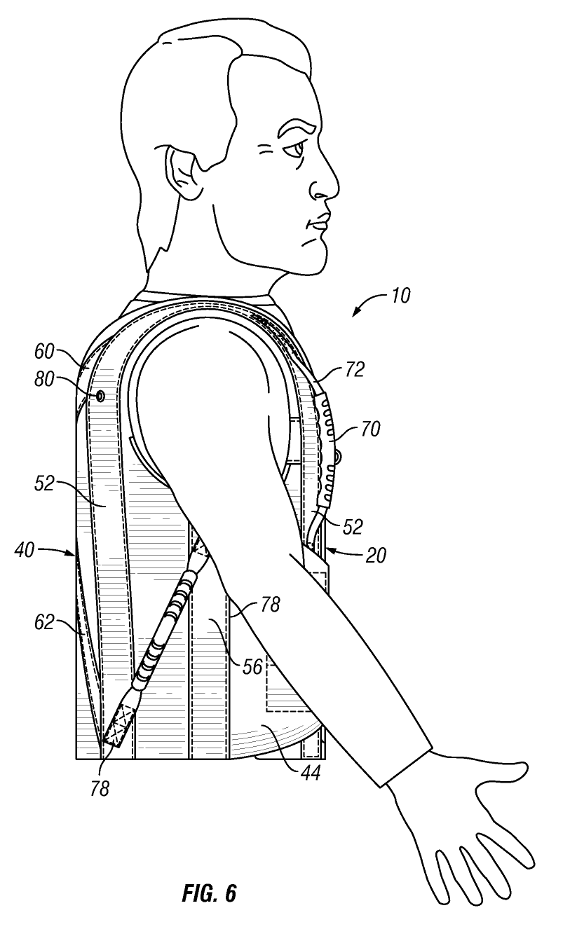

The one or more strategically positioned hand holds, which are attached to the support straps, draw on this structural web to enhance the leverage of the caregiver. Loads applied to the hand holds are transferred to a support strap, which in turn transfers and distributes the load to the other support straps and the unitary garment member 12. For example, as shown in FIGS. 4 and 6, the front hand holds 72, 73 are positioned so that they are situated adjacent to the patient's sternum region. In addition, a lateral hand hold 74 attached to the support straps 50, 52, 58 that spans the patient's sternum region may also be provided. By configuring readily accessible hand holds near the patient's chest area's center of mass the patient assistance device 10 enhances the caregiver's leverage, thereby enabling a caregiver to more easily assist a patient wearing the device to move from one position to another.

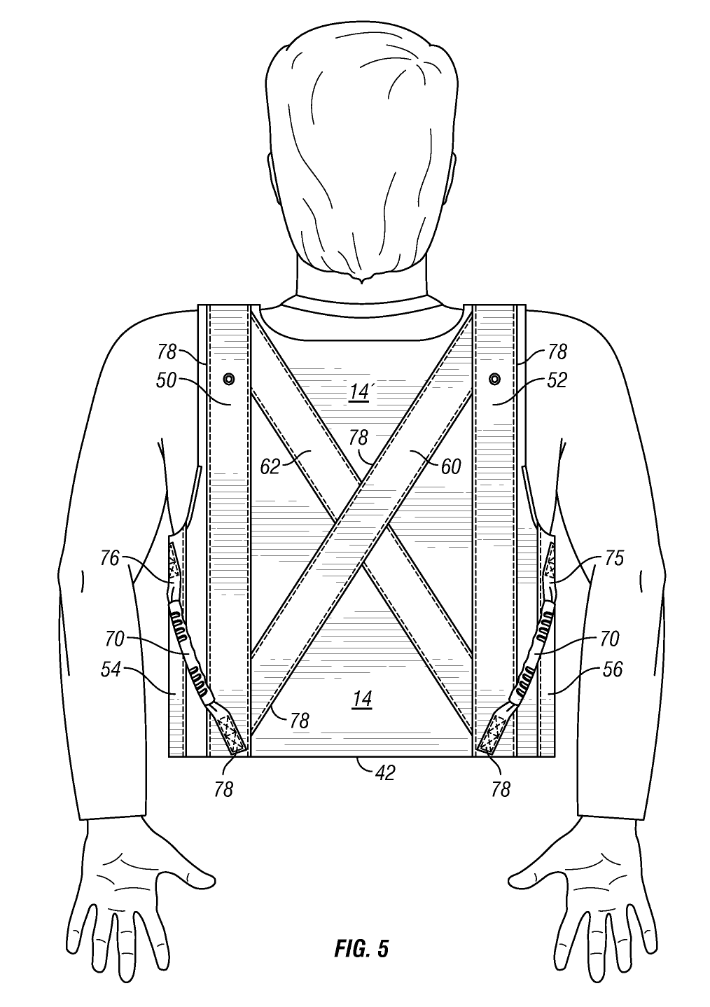

As shown in FIGS. 5 and 6, the two side hand holds 75, 76 have one end attached to its respective shoulder support straps and another end attached to its respective side support strap are also provided. For example, as illustrated in the depicted embodiment, the left side hand hold 76 has one end attached to the left shoulder support strap 50 near the bottom edge 42 of the rear panel section 40 and a second end attached near the top of the left side support strap 54. Similarly, the right side hand hold 75 has one end attached to the right shoulder support strap 52 near the bottom edge 42 of the rear panel section 40 and a second end attached near the top of the right side support strap 56. The two side hand holds 75, 76 provide improved leverage in moving a patient both laterally and vertically. For example the side hand holds 75, 76 can be used to assist the patient out of his bed or wheelchair, position him laterally on an MRI table or assist him when floating on his back or stomach in a water aerobics class. Moreover, by configuring the side hand holds 75, 76 so that they are not positioned on the patient's back when in a supine position, the side hand holds 75, 76 provide increased leverage without sacrificing patient comfort.

In addition, the subject patient assistance device 10 is inherently easier for a patient to put on and take off. In addition, it is more easily adjusted for a particular situation. For example, with the patient is in a sitting position, the assistance device 10 is situated over the patient so that the opening 32 is positioned over the patient's head. The assistance device 10 is then lowered over patient's head and draped across the patient's shoulders so that the front panel section 20 is configured in front of the patient's chest region and the rear panel section 40 is configured about the patient's back region. The two flap portions 44, 46 are then pulled forward and attached to the front panel section 20 by means of the previously disclosed hook-and-loop type attachment fabric. Thus, a patient does not have to raise his arms to put the device 10 on. Moreover, the fit of the patient assistance device 10 may be easily adjusted for changing circumstances. For example, just prior to lifting a patient using the subject patient assistance device 10, the two flap portions 44, 46 may be quickly repositioned closer to the each other on the attachment fabric 28 of the front panel section 20 so that the fit of the assistance device 10 is tighter and more secure. Upon completion of the lift or movement, the two flap portions 44, 46 may be quickly released or loosened from the attachment fabric 28 and repositioned to a more relaxed or comfortable fit.

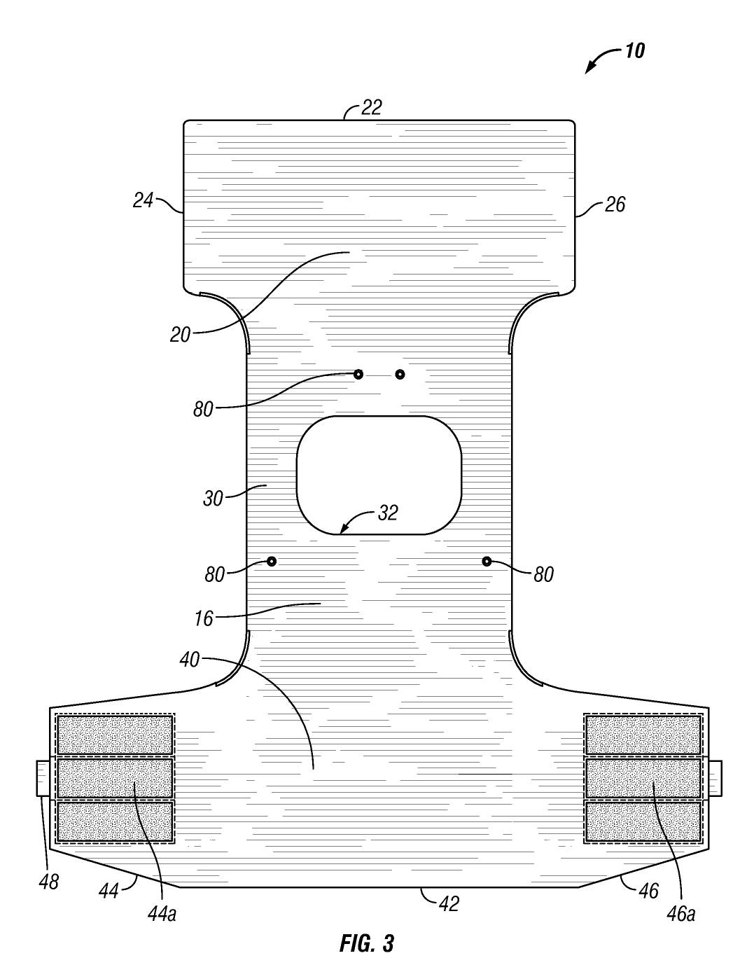

Moreover, the subject patient assistance device 10 is just as easy to put on a patient in a supine position. In this case the subject patient assistance device 10 is configured adjacent to the supine patient in a fully open position as shown in FIG. 3. The edge 42 of the rear panel section 40 is generally positioned even with the patient's waist so that the opening 32 in the middle panel section 30 is positioned adjacent with the patient's head. The patient can then be gently lifted while the flatly configured assistance device 10 is slid underneath. The front panel section 20 is then folded over and onto the patient's chest; whereupon the two flap portions 44, 46 are pulled forward and attached to the front panel section 20 as described previously. Once again, the patient does not have to raise his arms to put the device 10 on.

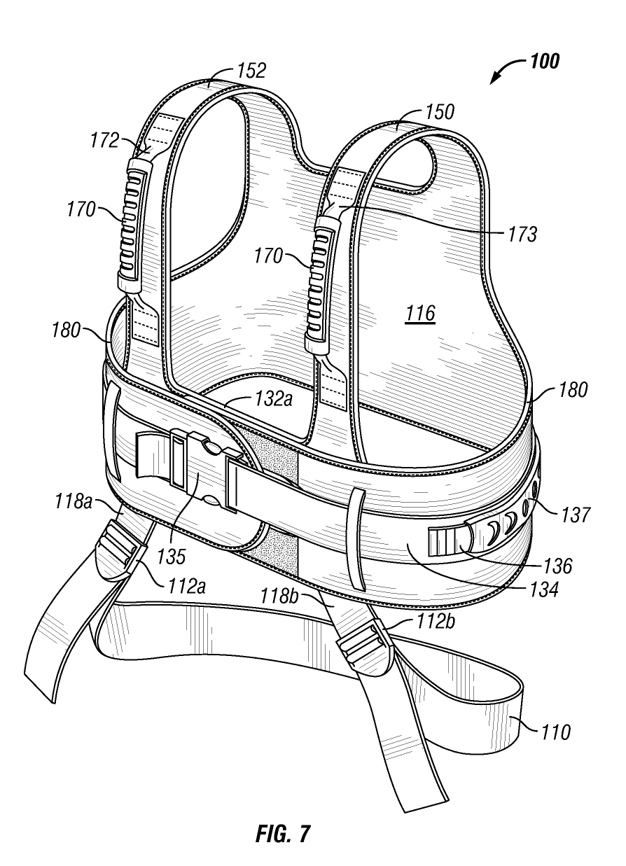

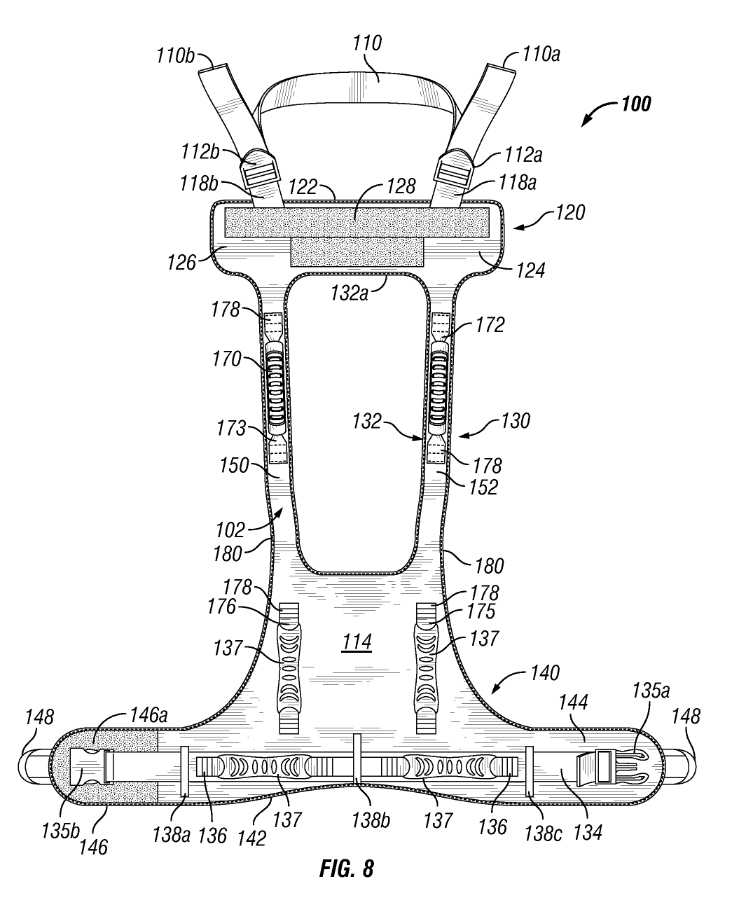

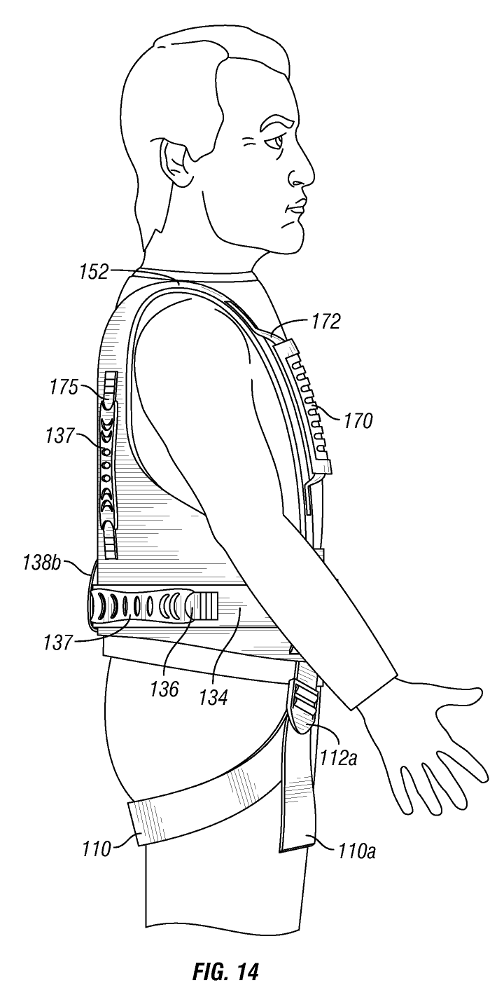

With reference now to FIGS. 7-14, and in particular FIGS. 7 and 8, a second embodiment of the patient assistance device 100 of the present invention is shown. The patient assistance device 100 comprises a reinforced poncho-vest garment worn by a patient. The device 100 assists caregivers in lifting and moving the patient in a wide variety of scenarios. The device 100 is designed to be easily donned and removed from a patient.

The patient assistance device 100 of the present invention comprises a poncho-style garment in the form of a unitary garment member 102 having a front panel section 120, a rear panel section 140 and a central or middle section 130 interconnecting the front and rear panel sections. As will be further disclosed below, the unitary garment member 102 is generally constructed of a flexible, durable material reinforced with strategically placed webbing straps. The front panel section 120 is sized and shaped to fit across the patient's solar plexus region while the rear panel section 140 is sized and shaped to fit across the patient's back. The central section 130 includes a large opening 132 in the unitary garment member 102 defining two laterally spaced shoulder straps 152, 150 that connect the front panel section 120 to the rear panel section 140. The front panel section 120 may further include wing portions 124, 126 that extend laterally from opposing sides of the front panel section 120.

The front panel section 120 of the second embodiment of the patient assistance device 100 is noticeably smaller and covers less of the patient's chest area than the front panel section 20 previously disclosed in first embodiment 10. This has been found to be advantageous for a number of reasons. For instance, the larger opening 132 in the unitary garment member 102 greatly facilitates the ease with which the patient assistance device 100 is donned over a patient's head. In addition, with less of the chest area covered the patient assistance device 100 is more comfortable for the patient to wear. Moreover, the longer shoulder straps 152, 150, particularly enhance the form and fit of the patient assistance device 100 by better accommodating the bust region on female patients.

The rear panel section 140 includes two flap portions 144, 146 extending laterally on opposing sides of the rear panel section 140. The two flap portions 144, 146 are designed to selectively attach to the front panel section 120 so that when properly configured the patient assistance device 100 effectively becomes a vest-type garment that completely surrounds the patient's torso. The fit of the vest-type garment device 100 is easily adjusted by varying the position of the two flap portions 144, 146 on the lateral width of the front panel section 120.

To facilitate the selective attachment of the flap portions 144, 146 to the front panel section 120, segments of the two flaps portions 144, 146 as well as the outer surface of the front panel section 120 may each include a layer of attachment fabric. For example, the inner-facing surface 116 of the flap portions 144, 146 may include a layer of attachment fabric in the form of hook-and-loop type fastening and the outer facing surface 114 of the front panel section 120 may include a layer of complementary attachment fabric.

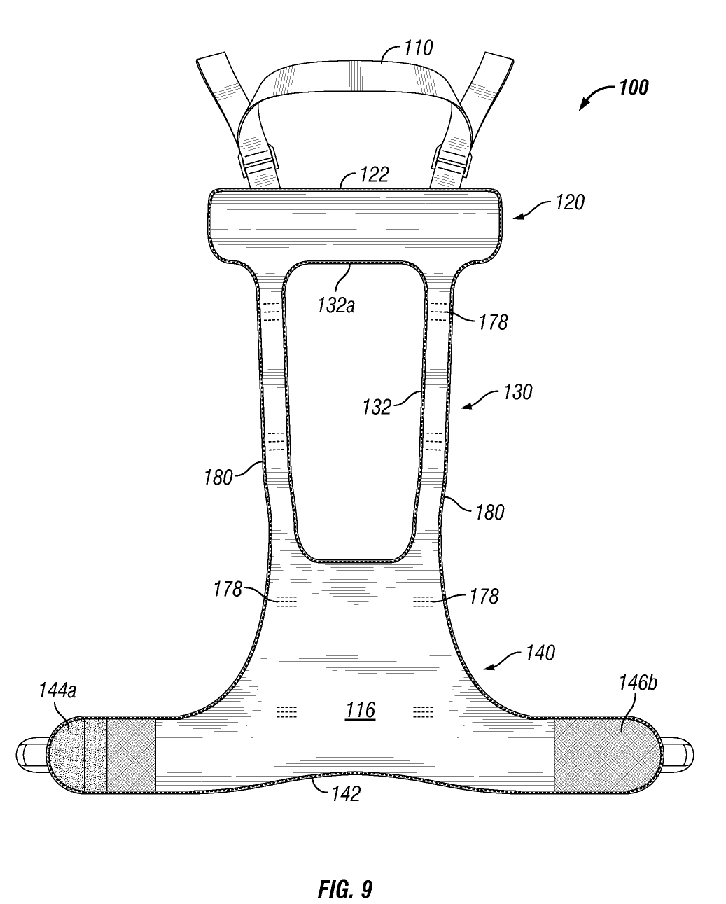

Alternatively, in a preferred embodiment the two flap portions 144, 146 are selectively attached to the front panel section 120 in an overlapping configuration. For example, as shown in FIGS. 8 and 9, segments on both sides of flap portion 146 are each covered with a layer of attachment fabric 146a, 146b in the form of hook-and-loop type fastening members. Correspondingly, a segment of the front panel section 120 and a segment of the interior surface of flap portion 144 each include a layer of complementary attachment fabric. For instance, segments 146a, 146b may comprise “loop” type attachment fabric while segments 128 and 144a comprise “hook” type attachment fabric. Thus, when the patient assistance device 100 is properly configured on a patient, the two flap portions 144, 146 of the rear panel section 140 are pulled forward underneath the patient's arms and attached to the front panel section in an overlapping configuration. First, the segment of attachment fabric 146a on the interior surface 116 of the left flap portion 146 is selectively attached to the segment of complementary attachment fabric 128 on the front panel section 120. Then, the right flap portion 144 is pulled across the left flap portion 146 in an overlapping configuration and the segment of attachment fabric 144a on the interior surface of right flap portion 144 is selectively attached to a segment of complementary attachment fabric 146a on the exterior surface of left flap portion 146.

Each of the flap portions 144, 146 may further include pull tabs 148 attached to the distal ends of the flap portions to provide leverage in pulling the two flap portions 144, 146 away from one another and the layer of the attachment fabric 128 attached to the front panel section 120.

The patient assistance device 100 further includes a waist belt 134, which includes an adjustable side-release buckle mechanism 135, configured over the flap portions 144, 146 so that when the patient assistance device 100 is properly configured on a patient, the belt 134 is approximately even with or preferably slightly above the patient's natural waistline. In a preferred embodiment, the waist belt 134 comprises a polyurethane-coated nylon webbing belt or strap, which is easy to clean and sanitize. The length of the waist belt 134 is adjustable by means of the ladder lock mechanism 135a attached to one end of the waist belt 134. The buckle mechanism 135a further includes prongs for engaging a side-release buckle mechanism 135b attached to the other end of the waist belt 134. The waist belt 134 is attached to the rear panel section 140 and flap portions 144, 146 by being thread through a series of belt loops 138 attached to the unitary garment member 102. The waist belt 134 may further include one or more lateral hand holds 136. The lateral hand holds 136 may further comprise flat handle grips 137, which improve the ergonomics and leverage of the hand holds 136.

The patient assistance device 100 further includes a “glute” strap 110 that when properly configured is attached to the front panel section 120 of the unitary garment member 102 and wraps around (i.e., extends laterally across) the gluteus maximus or buttocks of the patient. In the embodiment depicted in the Figures, two laterally-spaced extension straps 118a, 118b are fixably attached to the front panel section 120 of the unitary garment member 102 and include a ladder lock buckle 112a, 112b on their respective distal ends. The two laterally-spaced extension straps 118a, 118b are typically secured to reinforced support straps (e.g., 150a, 152a) incorporated into the unitary garment member 102. As will be later discussed in greater detail, the laterally-spaced extension straps 118a, 118b of the glute strap 110 may alternatively be attached to or incorporated into the waist belt 134.

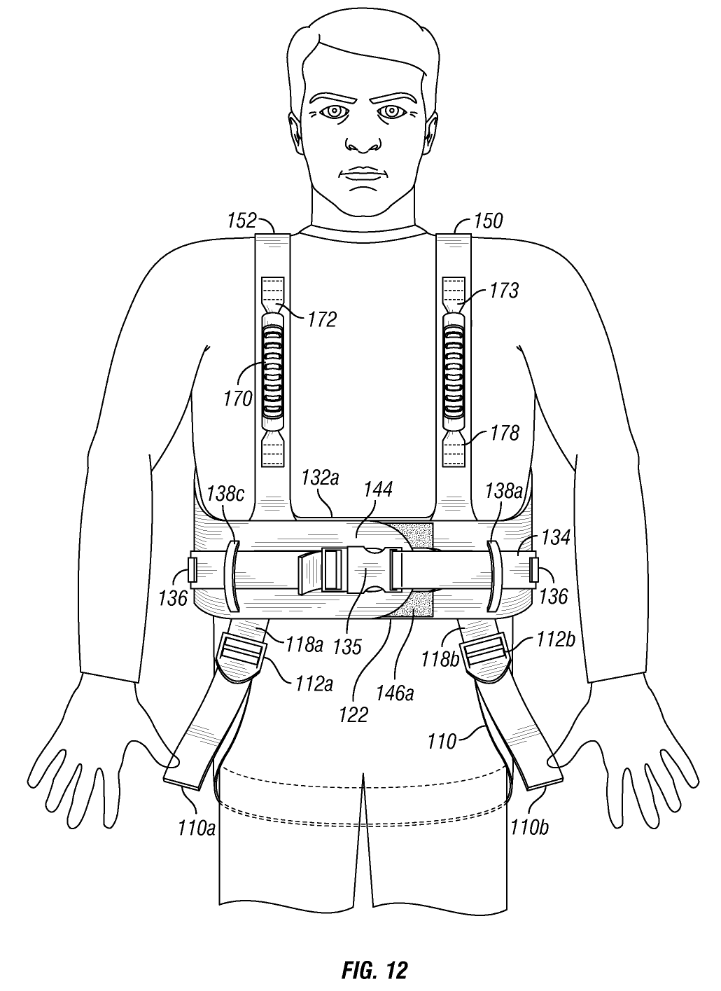

In a preferred embodiment, the extension straps 118a, 118b are angled away from one another to improve the ergonomics of the glute strap 110 when worn by a patient. For example, as shown in FIGS. 7 and 12, the extension straps 118a, 118b are positioned at an angled configuration of approximately 30° from vertical, which coincides with the angle of the glute strap 110 when secured around the patient's buttocks in the sitting position.

The distal ends 110a, 110b of the glute strap 110 are selectively secured in their respective ladder lock buckles 112a, 112b. The length of the glute strap 110 may be adjusted by pulling one or both distal ends 110a, 110b through its respective ladder lock buckle 112a, 112b until the glute strap 110 forms a snug fit about the patient's buttocks. In a preferred embodiment, the glute strap 110 comprises a polyurethane-coated nylon webbing belt or strap that is easy to clean and sanitize.

As mentioned previously, the unitary garment member 102 is generally constructed of a flexible, durable material reinforced with strategically placed webbing straps. For example, in one embodiment the material comprises a neoprene rubber material. Preferably, the material comprising the unitary garment member 102 is also bonded with an anti-microbial agent (e.g., AEM 5700) for added hygienic protection. In a one embodiment, the material comprises a polyester blend outer shell and multiple layers of neoprene rubber treated with an anti-microbial agent and bonded with adhesive under pressure. In a another embodiment, the neoprene layers are treated with an anti-microbial agent so as to form a covalent bond with the neoprene. While in one embodiment the front 120, central 130 and rear 140 panel sections of the unitary member 12 are constructed from a single, homogenous sheet of material, in other embodiments each panel section may be constructed separately of materials having different characteristics (e.g., buoyancy, strength, flexibility, etc.) and then attached to the other panel sections to form a unitary garment.

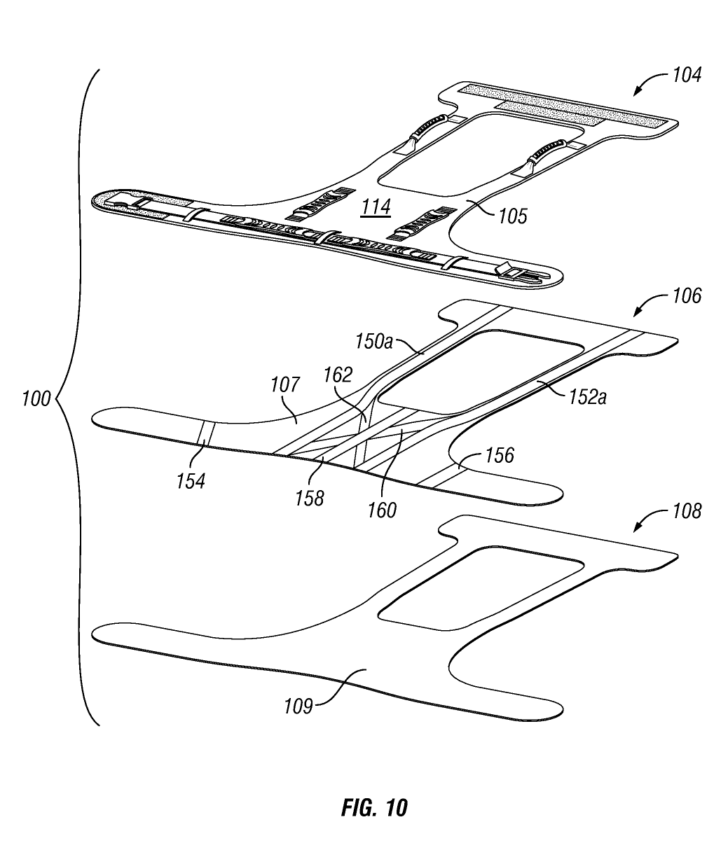

As shown in FIG. 10, in a preferred embodiment, the unitary garment member 102 comprises a multi-layered composite structure having a middle layer 106 sandwiched between an inner or interior layer 108 and outer or exterior layer 104. The multiple layers are then joined by adhesive bond, reinforced stitching or a combination thereof. For example, the patient assistance device 100 depicted in the Figures includes a reinforced stitched seam 180 about the outer perimeter of the unitary garment member 102. The inner circumference of the large opening 132 also includes a reinforced stitched seam. As will be explained subsequently in greater detail, various hand holds also include reinforced stitching 178 that further bonds the multiple layers together.

Each of the layers (e.g., 104, 106, 108) typically comprise a cloth template (e.g., 105, 107, 109) that is of substantially equivalent shape and size. The outer 104 and inner 108 layers typically include cloth templates constructed of material that is durable, yet comfortable; while the middle layer 106 comprises a cloth template 107 reinforced with strategically placed webbing straps. While each layer typically comprises a unitary template constructed from a single, uniform sheet of material, in other embodiments each template may be of composite construction and include portions constructed of materials having different characteristics (e.g., buoyancy, strength, flexibility, etc.).

In a preferred embodiment, the templates 105, 109 of the outer 104 and inner 108 layers are each constructed of a stretchable, fluid proof (i.e., non-permeable), yet breathable PU coated polyester knit textile material such as Tek-Stretch 2™ manufactured by Eastex Products, Inc. of Holbrook, Mass. The cloth template 107 of the middle layer 106 is constructed of a polyester spandex mesh spacer material that also acts as a padding agent for the unitary garment member 102. Each of the templates 105, 107, 109 may also include anti-microbial protection to address infection control issues for multiple patient use.

The unitary garment member 102 of patient assistance device 100 further includes a plurality of integral, reinforced support straps that are firmly attached and/or incorporated into the unitary garment member 102. The support straps are generally constructed of a reinforced webbing material that is flexible but stretch resistant. For example, in a preferred embodiment the support straps comprise ballistic nylon webbing. The support straps are incorporated into the unitary garment member 102 by adhesive bond, reinforced stitching or a combination thereof. The plurality of support straps enhance the structural integrity of the unitary garment member 102 by transferring and distributing a load applied to one support strap to the entire patient assistance device 100.

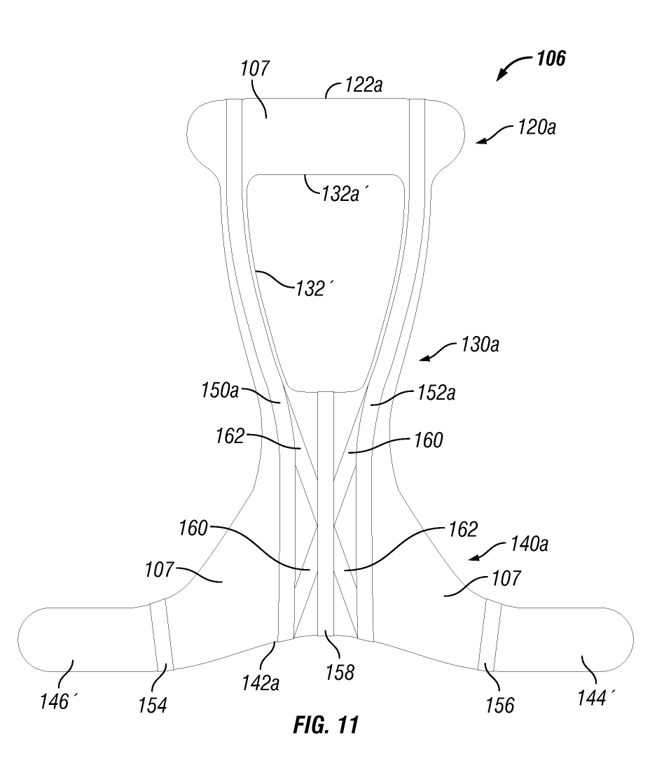

While the support straps may be applied to any of the multiple layers of the unitary garment member 102, in a preferred embodiment the support straps are incorporated into the template 107 of the middle layer 106. As shown in FIGS. 10 and 11, the plurality of support straps include two laterally spaced shoulder support straps 150a, 152a that extend longitudinally from the edge 142a of the rear panel section 140a of the middle layer template 107 to the edge 122a of the front panel section 120a of the middle layer template 107, and are configured on the of the middle layer template 107 (and correspondingly on the unitary garment member 102) so as to pass on opposing lateral sides of the opening 132′ in the middle section 130a of the template 107 of the middle layer 106.

In addition, two back support straps 160, 162 may be configured in a criss-cross or crossbuck arrangement across the rear panel section 140a of the template 107 of the middle layer 106. The ends of the back support straps 160, 162 are attached to the two shoulder support straps 150a, 152a thereby enhancing the structural rigidity of the rear panel section 140. The rear panel section 140a of the middle layer template 107 may further comprise an additional vertical support strap 158 on rear panel section 140a of the middle layer template 107 configured between the two laterally spaced shoulder support straps 150a, 152a. The vertical support strap 158 extends from the bottom edge 142a of the rear panel section 140a of the middle layer template 107 to the opening 132′ in the middle section 130a. Finally, each flap portion 144′, 146′ of the rear panel section 140a includes a support strap that is laterally spaced away from its respective shoulder support strap 150a, 152a.

The vertical support straps 154, 156, 158 may be used as anchor points for connecting the waist belt 134 to unitary garment member 102. For example, in one embodiment a belt loop 138 is fixably attached to each of the vertical support straps 154, 156, 158. The distal ends of each belt loop are aligned with and attached to its respective vertical support strap 154, 156, 158 incorporated into the unitary garment member 102 by adhesive bond, mechanical bond (e.g., rivets (not shown) or reinforced stitching) or a combination thereof.

With reference again to FIGS. 7-14, and in particular FIGS. 7 and 8, the patient assistance device 100 further includes one or more strategically positioned hand holds. The hand holds provide enhanced leverage, which enables a caregiver to more easily assist a patient wearing the device to move from one position to another. The hand holds comprise straps of reinforced webbing material fixably attached to the support straps. The ends of the hand holds are attached to the support straps incorporated into the unitary garment member 102 by adhesive bond, mechanical bond (e.g., rivets (not shown) or reinforced stitching 178) or a combination thereof. The hand holds may further comprise plastic handles grips 137, 170 attached to the straps.

The embodiment of the patient assistance device 100 depicted in FIGS. 7-14 includes multiple hand holds permanently attached to the unitary garment member 102. Matching front hand holds 172, 173 are configured on opposing support straps 152, 150 on the front panel section 120. The ends of the front hand holds 172, 173 are substantially aligned with and fixably attached to their respective support straps 152a, 150a incorporated into the middle section 130 of the unitary garment member 102 by adhesive bond, mechanical bond (e.g., rivets (not shown) or reinforced stitching 178) or a combination thereof. The front hand holds 172, 173 are positioned so that, when the vest device 100 is properly configured on a patient, they are situated adjacent to the patient's sternum region. Each front hand hold 172, 173 may further comprise a plastic cover handle 170 to improve the gripping power of a caregiver.

Similarly, the rear panel section 140 may also include a pair of vertical hand holds 175, 176 on the exterior surface of the unitary garment member 102. The ends of the vertical hand holds 175, 176 are substantially aligned with and fixably attached to their respective support straps 152a, 150a incorporated into the rear panel section 140 of the unitary garment member 102 by adhesive bond, mechanical bond (e.g., rivets (not shown) or reinforced stitching 178) or a combination thereof. Each vertical hand hold 175, 176 may further comprise a plastic cover handle 137 to improve the gripping power of a caregiver. Preferably, the plastic cover handle 137 is substantially flat along its length to minimize discomfort to a patient when sitting or lying down in a bed.

With reference FIGS. 12-14, the second embodiment of the patient assistance device 100 of the present invention is depicted as properly configured on a patient. Preferably, the patient wears a light fabric undergarment under the patient assistance device 100. The undergarment may also be treated with an anti-microbial agent for added hygienic protection. With the interior-facing surface 116 of the device 100 facing the patient, the patient's head is inserted through the opening 132 in the unitary garment member 102 so that the central section 130 is positioned over the patient's shoulders with the front panel section 120 configured over the patient's solar plexus region and the rear panel section 140 is situated over the patient's back. As shown in the Figures, when the patient assistance device 100 is properly positioned on a patient, the bottom edge 122 of the front panel section 120 and the bottom edge 142 of the rear panel section 140 are positioned adjacent to the patient's natural waistline region.

The two flap portions 144, 146 are then pulled forward and over the wings 124, 126 of the front panel section 120, and securely attached to the attachment fabric 128 on the front panel section 120, either in an adjacent configuration to one another, or preferably in an overlapping configuration as previously described. When thus attached, the two flap portions 144, 146 form a wide belt around the patient's torso effectively locking the patient assistance device 100 securely in place forming a snug fit with the patient. The front, central and rear panel sections of the unitary garment member 102 thus form a cohesive vest garment that surround the surround the patient's torso.

The length of the waist belt 134 may then be adjusted and the side-release buckle mechanism 135 engaged ensuring a comfortable, yet snug fit. Then one or both ends of the glute strap 110 may be loosened from its respective ladder lock buckle 112 and positioned laterally across the patient's buttocks prior to reengaging the distal ends of the glute strap 110 in their respective ladder lock buckle 112 to form a snug fit of the glute strap 110 around the patient's buttocks.

The plurality of integral, reinforced support straps provide further structural firmness and support to the patient assistance device 100. Moreover, when the patient assistance device 100 is properly configured as a cohesive vest garment on the patient, the reinforced support straps incorporated into the unitary garment member 102 provide a structural web of mutual support.

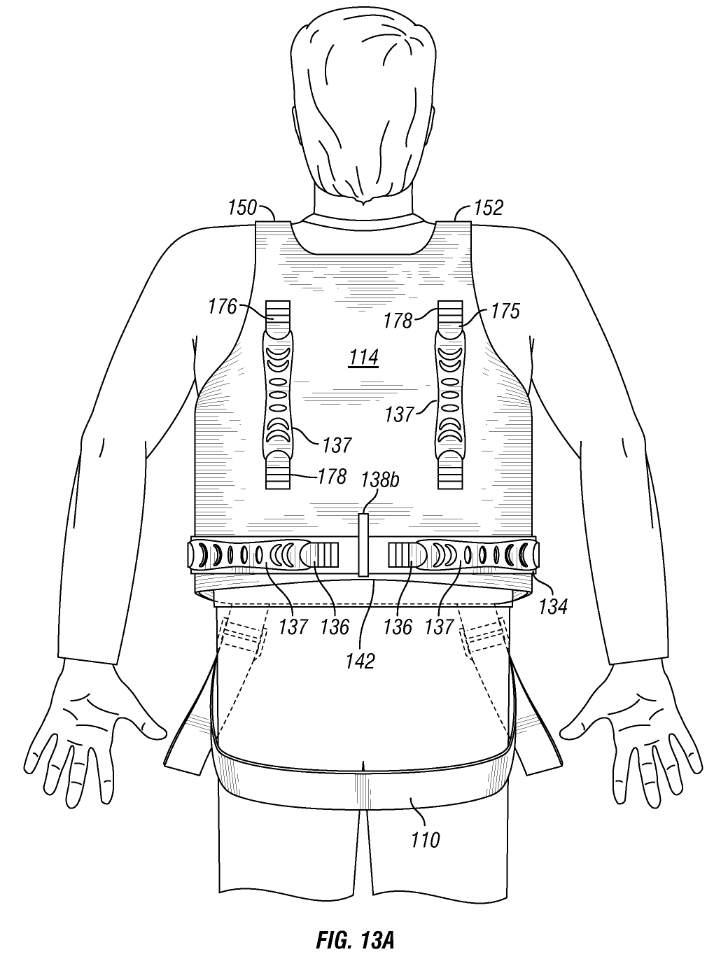

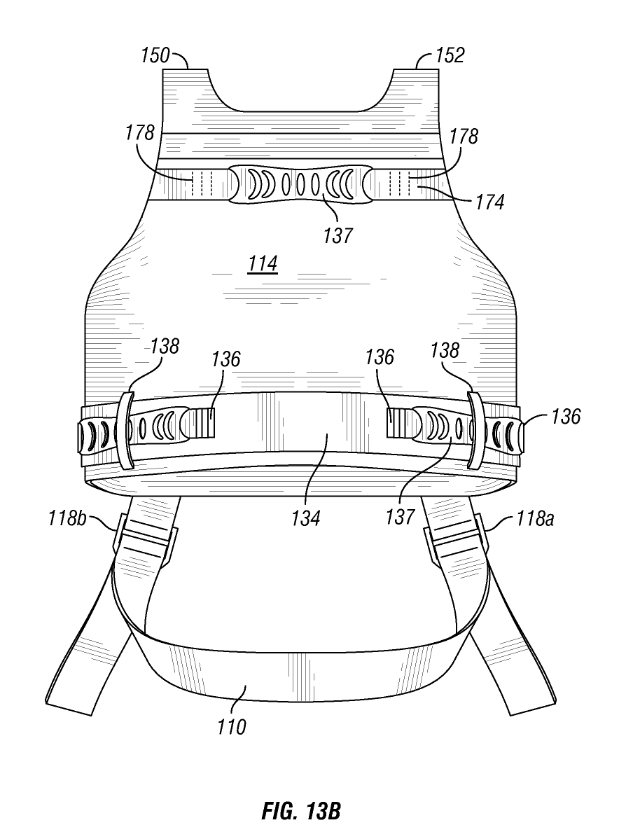

As shown in the Figures, the shoulder support straps 150a, 152a are aligned vertically on the unitary garment member 102. The front hand holds 172, 173 are substantially aligned with and fixably attached to their respective support straps 152a, 150a incorporated into the shoulder support strap 152, 150 of the middle section 130 of the unitary garment member 102. Likewise, as shown in FIG. 13A, the vertical hand holds 175, 176 on the exterior surface of the rear panel section 140 of the unitary garment member 102 are substantially aligned with and fixably attached to their respective support straps 152a, 150a incorporated into the rear panel section 140 of the unitary garment member 102. Alternatively, a lateral hand hold 174 may be aligned substantially perpendicular to and fixably attached to the support straps 152a, 150a incorporated into the rear panel section 140 of the unitary garment member 102, as shown in FIG. 13B. In addition, the flap support straps 154, 156 are similarly aligned vertically on their respective flap portions 144, 146 to provide support to belt loops 138. The two back support straps 160, 162 are also configured in a criss-cross or crossbuck arrangement across the rear panel section 140. The ends of the back support straps 160, 162 are attached to the two shoulder support straps 150a, 152a thereby enhancing the lateral structural rigidity of the rear panel section 140.

The one or more strategically positioned hand holds, which are attached to the support straps, draw on this structural web to enhance the leverage of the caregiver. Loads applied to the hand holds are transferred to a support strap, which in turn transfers and distributes the load to the other support straps and the unitary garment member 102. For example, as shown in FIG. 12, the front hand holds 172, 173 are positioned so that they are situated adjacent to the patient's sternum region. Correspondingly, the laterally-spaced extension straps 118a, 118b are fixably attached to ends of the reinforced support straps 152a, 150a in the front panel section 120. When the glute strap 110 is positioned laterally around the patient's buttocks and secured to the ladder lock buckles 112 attached to the extension straps 118, the glute strap 110 is effectively connected to the structural web of the unitary garment member 102. When configured on a sitting patient, the glute strap 110 prevents the unitary garment member 102 from riding up the torso of the patient when a caregiver applies lifting force to the front hand holds 172, 173. Moreover, the caregiver derives substantial leverage from the structural web of reinforced support straps, which transfers the lifting force on the front hand holds 172, 173 to the glute strap 110 positioned laterally across the patient's buttocks. By enhancing the caregiver's leverage and control, the patient assistance device 100 enables a caregiver to more easily assist a patient wearing the device to move from one position to another.

In addition, the subject patient assistance device 100 is inherently easier for a patient to put on and take off. It is also more easily adjusted for a particular situation. For example, with the patient is in a sitting position, the assistance device 100 is situated over the patient so that the interior-facing surface 116 of the device 100 is facing the patient and the opening 132 is positioned over the patient's head. The assistance device 100 is then lowered over patient's head and draped across the patient's shoulders so that the front panel section 120 is configured in front of the patient's solar plexus region and the rear panel section 140 is situated about the patient's back region. The two flap portions 144, 146 are pulled forward and attached to the front panel section 120 as described previously. The waist belt 134 may then be sized and adjusted to ensure a snug fit, and the side-release buckle mechanism 135 engaged. Then one or both ends of the glute strap 110 may be loosened from its respective ladder lock buckle 112 and gently positioned laterally under the patient's buttocks prior to reengaging the distal ends of the glute strap 110 in their respective ladder lock buckle 112 to form a snug fit of the glute strap 110 around the patient's buttocks. Thus, a patient does not have to raise his arms to put the device 100 on. Moreover, the fit of the patient assistance device 100 may be easily adjusted for changing circumstances. For example, just prior to lifting a patient using the subject patient assistance device 100, the fit of the waist belt 134 or the glute strap 110 may be tightened. Upon completion of the lift or movement, the waist belt 134 or the glute strap 110 may be quickly released or loosened and repositioned to a more relaxed or comfortable fit.

Moreover, the subject patient assistance device 100 is just as easy to put on a patient in a supine position. In this case the subject patient assistance device 100 is configured adjacent to the supine patient in a fully open position as shown in FIG. 9. The edge 142 of the rear panel section 140 is generally positioned even with the patient's waistline so that the opening 132 in the middle section 130 is positioned adjacent with the patient's head. The patient can then be gently lifted while the flatly configured assistance device 100 is slid underneath. The front panel section 120 of the unitary garment member 102 is then folded over and onto the patient's chest; whereupon the two flap portions 144, 146 are pulled forward and attached to the front panel section 120 as described previously. The waist belt 134 may be sized and adjusted ensuring a snug fit, and the side-release buckle mechanism 135 engaged. Then one or both ends of the glute strap 110 may be loosened from its respective ladder lock buckle 112 and gently positioned laterally under the patient's buttocks prior to reengaging the distal ends of the glute strap 110 in their respective ladder lock buckle 112 to form a snug fit of the glute strap 110 around the patient's buttocks. Once again, the patient does not have to raise his arms to put the device 100 on.

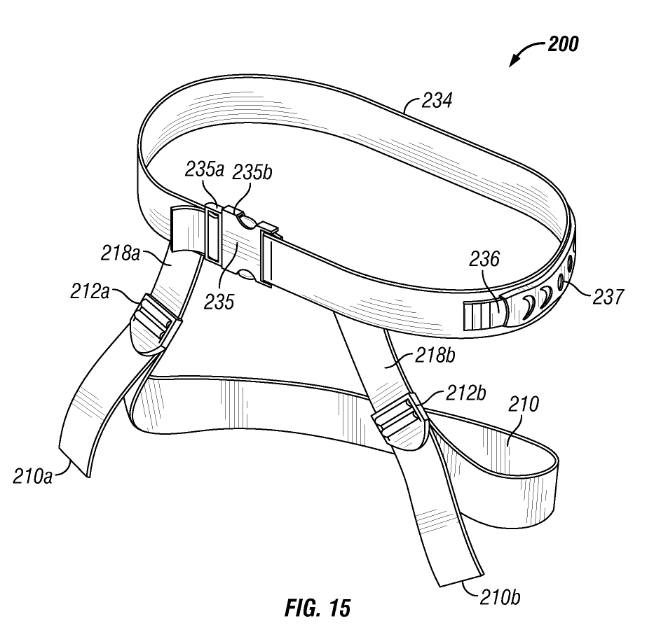

With reference now to FIG. 15, a third embodiment of the patient assistance device 200 of the present invention is shown. The patient assistance belt device 200 comprises a reinforced waist or gait belt (i.e., a combination waist belt 234 and glute strap 210) worn by a patient. The patient assistance belt device 200 assists caregivers in lifting and moving the patient in a wide variety of scenarios. The belt device 200 is designed to be easily donned and removed from a patient.

The patient assistance belt device 200 includes a waist belt 234, which includes an adjustable side-release buckle mechanism 235. When the patient assistance belt device 200 is properly configured on a patient, the belt 234 is approximately even with or preferably slightly above the patient's natural waistline. In a preferred embodiment, the waist belt 234 comprises a polyurethane-coated nylon webbing belt or strap, which is easy to clean and sanitize. The length of the waist belt 234 is adjustable by means of the ladder lock mechanism 235a attached to one end of the waist belt 234. The buckle mechanism 235a further includes prongs for engaging a side-release buckle mechanism 235b attached to the other end of the waist belt 234.

The patient assistance belt device 200 may further include one or more lateral hand holds 236 configured along the length of the waist belt 234. The lateral hand holds 236 may further comprise flat handle grips 237, which improve the ergonomics and leverage of the hand holds 236.

The patient assistance belt device 200 further includes a “glute” strap 210 that includes two laterally-spaced extension straps 218a, 218b securely attached to or incorporated into the waist belt 234. In a preferred embodiment, the extension straps 218a, 218b are angled away from one another to improve the ergonomics of the glute strap 210 when worn by a patient. For example, as shown in FIG. 15, the extension straps 218a, 218b are positioned at an angled configuration of approximately 30° from vertical, which corresponds to the angle of the glute strap 210 when secured around the patient's buttocks in the sitting position.

The distal ends 210a, 210b of the glute strap 210 are selectively secured in their respective ladder lock buckles 212a, 212b. The length of the glute strap 210 may be adjusted by pulling one or both distal ends 210a, 210b through its respective ladder lock buckle 212a, 212b until the glute strap 210 forms a snug fit about the patient's buttocks. In a preferred embodiment, the glute strap 210 comprises a polyurethane-coated nylon webbing belt or strap that is easy to clean and sanitize.

It will now be evident to those skilled in the art that there has been described herein an improved lifting assistance device. The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

Although the invention hereof has been described by way of a preferred embodiment, it will be evident that other adaptations and modifications can be employed without departing from the spirit and scope thereof. For example, the patient assistance belt device (i.e., combination waist belt/glute strap) disclosed in the third embodiment may be incorporated as the waist belt and glute strap in the second embodiment of the patient assistance device or in conjunction with the first embodiment of the patient assistance device. The terms and expressions employed herein have been used as terms of description and not of limitation; and thus, there is no intent of excluding equivalents, but on the contrary it is intended to cover any and all equivalents that may be employed without departing from the spirit and scope of the invention.

We claim:

1. A patient assistance device, which enables a caregiver to assist a patient in moving from one position to another, comprising:
a waist belt having a buckle mechanism for selectively attaching around said patient's waist; and
a glute strap having two ends that are attached to the front of said waist belt, wherein said glute strap is configured to wraparound said patient's buttocks region.

2. The device of claim 1 further comprising two laterally-spaced extension straps fixably attached to front of said waist belt, said extension straps including a ladder lock buckle for receiving one of said two ends of said glute strap.

3. The device of claim 2, wherein said extension straps are angled away from one another and positioned at an angled configuration of approximately 30° from vertical.

4. The device of claim 1, wherein said waist belt and glut belt each comprise a length of polyurethane-coated nylon webbing.

5. The device of claim 1, wherein said buckle mechanism further includes a mechanism for adjusting the length of said waist belt.

6. The device of claim 1, wherein said waist belt further comprises at least one hand hold configured thereon.

7. The device of claim 6, wherein said hand hold further includes a flat handle grips.

8. The device of claim 1 further comprising:
a unitary garment member fixably attached to said waist belt, said garment member having an inner-facing surface and an outer-facing surface, and including a front panel section, a middle section and a rear panel section, said front panel section having a layer of attachment fabric attached to its outer-facing surface, said middle section having a head opening formed therethrough; said rear panel section having two flap portions extending laterally on opposing sides of said rear panel section, each of said flap portions having a layer of attachment fabric attached to at least one of its respective facing surfaces, wherein by pulling said flap portions forward and attaching to said front panel section, a cohesive vest garment surrounding the patient's torso is formed; and
a plurality of hand holds fixably attached to said unitary garment member.

9. The device of claim 8 wherein said unitary garment member includes a plurality of support straps fixably attached to said unitary garment member, said plurality including:
a first strap extending longitudinally from an edge of said rear panel section to an edge of said front panel section; and
a second strap extending longitudinally from said edge of said rear panel section to said edge of said front panel section; said first and second straps configured on opposing sides of said head opening.

10. The device of claim 9 wherein said plurality of hand holds includes a first hand hold fixably attached to a portion of said first strap on said middle section; a second hand hold fixably attached to a portion of said second strap on said middle section; so that when said unitary garment member is properly configured on said patient, said first and second hand holds are positioned adjacent to patient's sternum.

11. A patient assistance device for assisting a caregiver in moving a patient from one position to another, comprising:
a unitary garment member having an inner-facing surface and an outer-facing surface, said garment member including a front panel section, a middle section and a rear panel section, said front panel section having a layer of attachment fabric attached to its outer-facing surface, said middle panel section having a head opening formed therethrough; said rear panel section having two flap portions extending laterally on opposing sides of said rear panel section, each of said flap portions having a layer of attachment fabric attached to at least one of its respective facing surfaces, wherein by pulling said flap portions forward and attaching to said front panel section, a cohesive vest garment surrounding the patient's torso is formed;
a waist belt connected to said unitary garment member and having a buckle mechanism for selectively attaching around said patient's waistline region; and
a glute strap having two ends that are attached to the front panel section of said unitary garment member, wherein said glute strap is configured to wraparound said patient's buttocks region.

12. The patient assistance device of claim 11, wherein said unitary garment member includes a plurality of support straps fixably attached to said unitary garment member, said plurality including:
a first strap extending longitudinally from an edge of said rear panel section to an edge of said front panel section; and
a second strap extending longitudinally from said edge of said rear panel section to said edge of said front panel section; said first and second straps configured on opposing sides of said head opening.

13. The patient assistance device of claim 12, further comprising a plurality of hand holds fixably attached to said unitary garment member.

14. The patient assistance device of claim 13, wherein said plurality of hand holds includes a first hand hold fixably attached to a portion of said first strap on said middle section; a second hand hold fixably attached to a portion of said second strap on said middle section; so that when said unitary garment member is properly configured on said patient, said first and second hand holds are positioned adjacent to patient's sternum.

15. The patient assistance device of claim 11 further comprising two laterally-spaced extension straps fixably attached to the front panel section of said unitary garment member, said extension straps including a ladder lock buckle for receiving one of said two ends of said glute strap

16. The patient assistance device of claim 15, wherein said extension straps are angled away from one another and positioned at an angled configuration of approximately 30° from vertical.

17. The patient assistance device of claim 11, wherein said waist belt and glut belt each comprise a length of polyurethane-coated nylon webbing.

18. The patient assistance device of claim 11, wherein said waist belt further comprises at least one hand hold configured thereon.

19. The patient assistance device of claim 11, wherein said support straps are comprised of a reinforced webbing material that is flexible but stretch resistant.

20. The patient assistance device of claim 18 wherein said unitary garment member comprises a multi-layered composite structure having a middle layer sandwiched between a first and second layer.
